(19) United States
(12) Patent Application Publication
(10) Pub. No.: US 2007/0220228 A1
(43) Pub. Date: Sep. 20, 2007

(54) Computer memory configuration inspection method and system

(75) Inventor: Kun-Hung Huang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/376,779

(22) Filed: Mar. 15, 2006

(51) Int. Cl. G06F 12/00

(52) U.S. Cl. 711/170

(57) ABSTRACT

A computer memory configuration inspection method and system method and system is proposed, which is designed for use with a computer motherboard for providing a memory configuration inspection function, and which is characterized by the utilization of an embedded set of memory specification data that are factory-stored in each DIMM memory module to determine whether the actual configuration of the installation of the DIMM memory modules is correct. This feature allows the user to be unnecessary to be familiar with DIMM's technical specification and nevertheless be able to install DIMM memory modules in correct configuration on the motherboard.

### BACKGROUND OF THE INVENTION

1. Field of the Invention

This invention relates to information technology (IT), and more particularly, to a computer memory configuration inspection method and system which is designed for use in conjunction with a computer motherboard for providing the computer motherboard with a memory configuration inspection function that can automatically inspect a group of memory modules, such as DIMM (Dual Inline Memory Module) memory modules installed on the motherboard to check if the DIMM memory modules are installed in correct configuration.

2. Description of Related Art

DIMM (Dual Inline Memory Module) is a type of computer memory widely utilized on computer motherboards to server as the primary memory of computer systems. In practice, a computer motherboard is provided with a plurality of memory slots each of which can be used for the installation of one DIMM memory module. Presently, various types of DIMM memory modules are available, including DDR-33 MHz to DDR-400 MHz memory modules (where DDR=Double Date Rate).

In the past, traditional non-DIMM memory modules can be inserted to the memory slots on a computer motherboard in arbitrary manners, i.e., each memory module can be inserted to any one of the memory slots on the motherboard without any restrictions in sequential order or position. However, today's DIMM memory modules are specially designed to be used in pairs or groups rather than used individually, such that when the user wants to install a group of DIMM memory modules to the motherboard, these DIMM memory modules should be plugged to the memory slots in a particular sequential order and in specific slot positions based on a specified configuration rule. If any one of the DIMM memory modules is installed in an incorrect slot position or all of the DIMM memory module are installed in an incorrect sequential order, the installed DIMM memory module will be unusable, or cause the computer system to operate abnormally.

One drawback to the above-mentioned configuration requisite in DIMM installation, however, is that it requires the user to be familiar with the DIMM configuration rule before the user can install the DIMM memory module in correct configuration on the motherboard, but in many cases, the DIMM configuration rule is quite difficult to understand even for learned users. For this sake, the installation of DIMM memory modules onto the motherboard is usually a tedious task that often results in incorrect installations.

### SUMMARY OF THE INVENTION

It is therefore an objective of this invention to provide a computer memory configuration inspection method and system which can automatically inspect whether a group of DIMM memory modules installed on a computer motherboard are correctly configured or not.

The computer memory configuration inspection method and system according to the invention is designed for use in conjunction with a computer motherboard for providing the computer motherboard with a memory configuration inspection function that can automatically inspect a group of memory modules, such as DIMM (Dual Inline Memory Module) memory modules installed on the motherboard to check if the DIMM memory modules are installed in correct configuration.

The computer memory configuration inspection method according to the invention comprises: (1) responding to a startup of the computer motherboard by reading an embedded set of memory specification data from each installed memory module on the computer motherboard; (2) detecting the actual configuration of each installed memory module on the computer motherboard; (3) comparing the actual configuration of each install memory module against each memory module's embedded memory specification data to check if each memory module is installed in correct configuration; and if any memory module is incorrectly installed in configuration, issuing a corresponding informing-enable message; and (4) responding to the informing-enable message by producing a configuration error message in a human-perceivable form.

In architecture, the computer memory configuration inspection system is based on an object-oriented component model which comprises: (A) a specification data reading module, which is capable of responding to a startup of the computer motherboard by reading an embedded set of memory specification data from each installed memory module on the computer motherboard; (B) a configuration detecting module, which is capable of detecting the actual configuration of each installed memory module on the computer motherboard; (C) a comparison module, which is capable of comparing the actual configuration of each install memory module detected by the configuration detecting module against each memory module's embedded memory specification data retrieved by the specification data reading module to check if each memory module is installed in correct configuration; and if any memory module is incorrectly installed in configuration, capable of issuing a corresponding informing-enable message; and (D) an informing module, which is capable of responding to the informing-enable message from the comparison module by producing a configuration error message in a human-perceivable form.

The computer memory configuration inspection method and system according to the invention is characterized by the utilization of an embedded set of memory specification data that are factory-stored in each DIMM memory module to determine whether the actual configuration of the installation of the DIMM memory modules is correct. This feature allows the user to be unnecessary to be familiar with DIMM's technical specification and nevertheless be able to install DIMM memory modules in correct configuration on the motherboard.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer memory configuration inspection system according to the invention in conjunction with a computer motherboard;

FIG. 2 is a schematic diagram showing an object-oriented component model of the computer memory configuration inspection system according to the invention;

FIG. 3 is a schematic diagram showing the embedding of an SPD memory specification data storage area in a DIMM memory module; and

FIG. 4 is a schematic diagram showing an example of a screen display utilized by the computer memory configuration inspection system of the invention to display a configuration error message in text form.

### DETAILED DESCRIPTION OF PREFERRED EMBODIMENTS

The computer memory configuration inspection method and system according to the invention is disclosed in full details by way of preferred embodiments in the following with reference to the accompanying drawings.

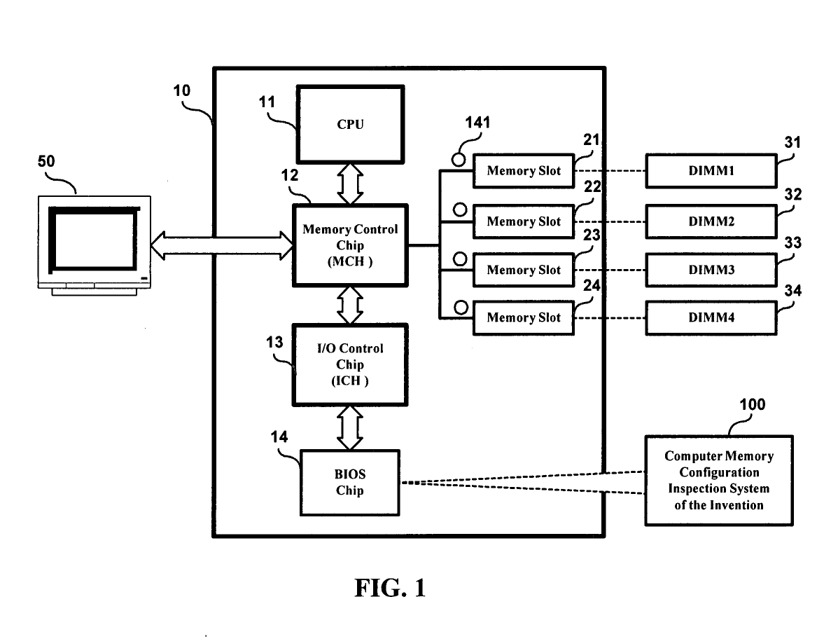

FIG. 1 is a schematic diagram showing the application of the computer memory configuration inspection system according to the invention (as the block indicated by the reference numeral 100 in FIG. 1). As shown, the computer memory configuration inspection system of the invention 100 is designed for use in conjunction with a computer motherboard 10 which is equipped with a central processing unit (CPU) 11, a memory control chip 12, an I/O (input/output) control chip 13, and a BIOS (Basic Input/Output System) chip 14 (it is to be noted that the computer motherboard 10 shown in FIG. 1 may further include many various other components; but for simplification of the drawings, only those related to the invention are shown). In the embodiment of FIG. 1, for example, the CPU 11 is an Intel processor; the memory control chip 12 is an MCH (Memory Control Hub) chipset developed by the Intel Corporation of USA, such as an Intel Blackford chipset, which is specifically designed to control the data exchange between the CPU 11 and the memory modules 31, 32, 33, 34 installed on the memory slots 21, 22, 23, 24; the I/O (input/output) control chip 13 is an ICH (I/O Control Hub) chipset developed by the Intel Corporation of USA, such as an Intel Southbridge chipset, which is specifically designed to control the data exchange between the CPU 11 and the BIOS chip 14 (note that the MCH memory control chip 12 and the ICH I/O control chip 13 further include many various other interface control functions; but since these functions are irrelevant to the invention, detailed description thereof will not be given in this specification).

It is to be noted that in the embodiment of FIG. 1, only 4 memory slots 21, 22, 23, 24 are shown for demonstrative purpose; but in practice, the number of the memory slots is unrestricted, and can be 8 or more. Moreover, different models of memory control chips from different developers might have different configuration rules.

During actual operation, the computer memory configuration inspection system of the invention 100 is capable of providing a memory configuration inspection function for a group of memory modules, such as DIMM (Dual Inline Memory Module) memory modules 31, 32, 33, 34, that are inserted to the memory slots 21, 22, 23, 24, for the purpose of checking whether the installed DIMM memory modules 31, 32, 33, 34 are correctly installed in configuration, i.e., whether the DIMM memory modules 31, 32, 33, 34 are installed in a correct sequential order and in correct slot positions.

As shown in FIG. 3, it is a prerequisite to the utilization of the invention that each of the DIMM memory modules 31, 32, 33, 34 is predefined with an embedded memory specification data storage area 40, such as a SPD (Serial Presence Detect) storage area defined in compliant with standard DIMM specifications. The SPD memory specification data storage area 40 is embedded for the storage of a set of memory specification data about the associated DIMM memory module, where the memory specification data includes, for example, memory capacity, operating frequency (i.e., DDR-266 MHz or DDR-333 MHz), production serial number, name of manufacturer, to name a few.

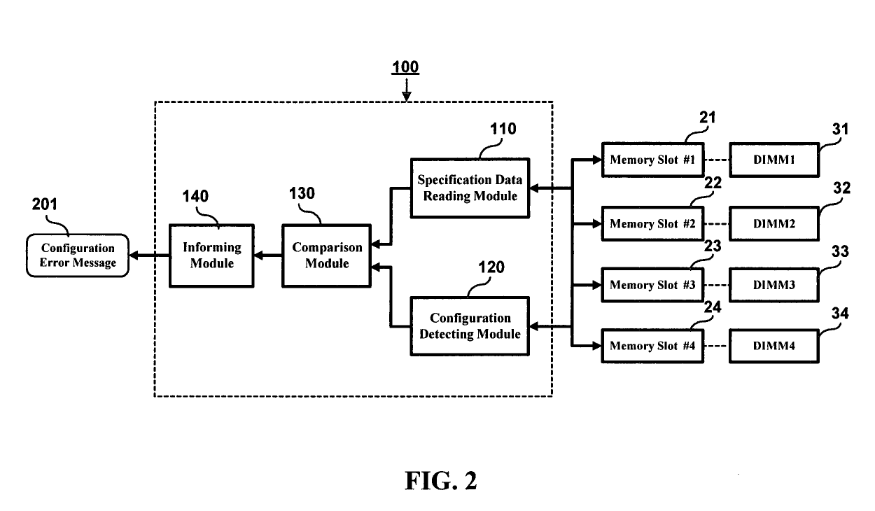

As shown in FIG. 2, in architecture, the computer memory configuration inspection system of the invention 100 is based on an object-oriented component model which comprises: (A) a specification data reading module 110; (b) a configuration detecting module 120; (C) a comparison module 130; and (D) an informing module 140. In practical implementation, the constituent components of the invention (i.e., the specification data reading module 110, the configuration detecting module 120, the comparison module 130, and the informing module 140) can be fully realized by computer code and integrated as an add-on firmware module to the BIOS code stored in the BIOS chip 14 for execution by the CPU 11 to provide the intended memory configuration inspection function.

Firstly, the respective attributes and behaviors of the specification data reading module 110, the configuration detecting module 120, the comparison module 130, and the informing module 140 are described in details in the following.

The specification data reading module 110 is capable of being activated in response to an event that the power of the computer motherboard 10 is turned on after the DIMM memory modules 31, 32, 33, 34 are readily installed on the memory slots 21, 22, 23, 24; and when activated, is capable of gaining access to the SPD memory specification data storage area 40 in each of the DIMM memory modules 31, 32, 33, 34 to read out the embedded memory specification data therefrom.

The configuration detecting module 120 is capable of being activated after the DIMM memory modules 31, 32, 33, 34 are readily installed on the memory slots 21, 22, 23, 24 and the computer motherboard 10 is powered on; and when activated, is capable of detecting the actual configuration (i.e., sequential order and slot position) of the installation of the DIMM memory modules 31, 32, 33, 34 on the memory slots 21, 22, 23, 24.

The comparison module 130 is capable of comparing the actual configuration of the DIMM memory modules 31, 32, 33, 34 detected by the configuration detecting module 120 against the embedded memory specification data retrieved by the specification data reading module 110 from the DIMM memory modules 31, 32, 33, 34 to check if everyone of the DIMM memory modules 31, 32, 33, 34 is correctly installed in configuration. If any one of the DIMM memory modules 31, 32, 33, 34 is incorrectly installed in configuration, the comparison module 130 will issue a corresponding informing-enable message to the informing module 140.

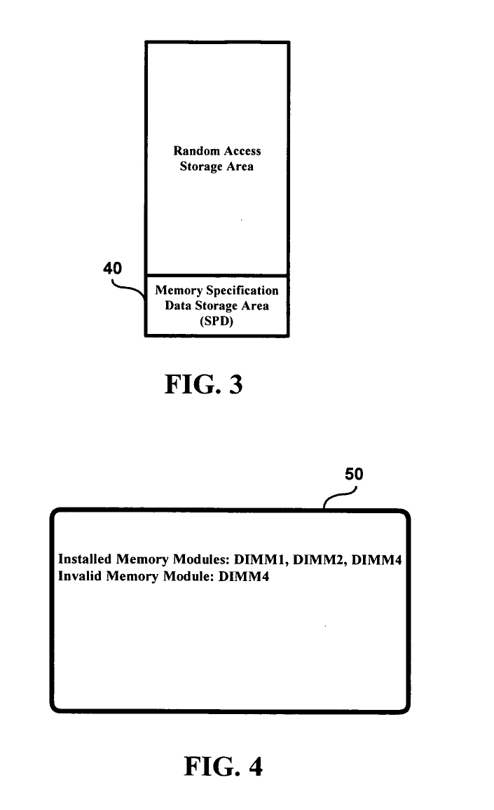

The informing module 140 is capable of responding to the informing-enable message from the comparison module 130 by displaying a configuration error message 201 in a human-perceivable form. In actual implementation, the informing module 140 can display the configuration error message 201 by using two different methods. The first method is to install an array of LED (Light-Emitting Diode) units 141 beside the memory slots 21, 22, 23, 24 as shown in FIG. 1, such that when any one of the DIMM memory modules 31, 32, 33, 34 installed on the memory slots 21, 22, 23, 24 is incorrect in configuration, its neighboring one of the LED units 141 will be lighted up. The second method is to display the configuration error message 201 in text or graphic form on a monitor screen 50 as demonstratively illustrated in FIG. 4.

The following is a detailed description of a practical application example of the computer memory configuration inspection system of the invention 100 in actual operation. In this application example, it is assumed that the computer motherboard 10 is provided with 4 memory slots 21, 22, 23, 24 for installation with a maximum of 4 DIMM memory modules 31, 32, 33, 34; and it is further assumed that in accordance with a configuration rule specified by the MCH memory control chip 12, the 4 DIMM memory modules 31, 32, 33, 34 can only be installed in two configuration manners: the first configuration manner is to install just two DIMM memory modules 31, 32 in pair to the first two memory slots 21, 22 on the computer motherboard 10; and the second configuration manner is to install all of the four DIMM memory modules 31, 32, 33, 34 in a specified sequential order to the memory slots 21, 22, 23, 24 (note that the configuration manners depicted here are only used for demonstrative purpose; and in practice, different models of memory control chips from different developers might have different configuration rules). Further, it is assumed that the user mistakenly install 3 DIMM memory modules 31, 32, 34 to the memory slots 21, 22, 24, wherein the first two DIMM memory modules 31, 32 are installed correctly, but the last DIMM memory module 34 is incorrectly installed based on the above-mentioned example of configuration rule.

Referring to FIG. 1 through FIG. 4 together, after the user inserts the above mentioned 3 DIMM memory modules 31, 32, 34 to the memory slots 21, 22, 24 and then turns on the power of the computer motherboard 10, it promptly activates the computer memory configuration inspection system of the invention 100 integrated to the BIOS code in the BIOS chip 14 to perform a memory configuration inspection procedure.

During the memory configuration inspection procedure, the first step is to activate the specification data reading module 110 to gain access to the SPD memory specification data storage area 40 in each of the DIMM memory modules 31, 32, 34 to read out the embedded memory specification data therefrom. Subsequently, the configuration detecting module 120 is activated to detect the actual configuration of the installed DIMM memory modules 31, 32, 34 on the memory slots 21, 22, 24. Next, the comparison module 130 is activated to compare the actual configuration of the DIMM memory modules 31, 32, 34 detected by the configuration detecting module 120 against the embedded memory specification data retrieved by the specification data reading module 110 from the DIMM memory modules 31, 32, 34 to check if these DIMM memory modules 31, 32, 34 are correctly installed in correct configuration based on the embedded memory specification data.

In this application example, since the last DIMM memory module 34 is incorrectly installed on the memory slot 24, the comparison module 130 responsively issues a corresponding informing-enable message to the informing module 140, thereby activating the informing module 140 to produce a configuration error message 201 which is presented in a user-perceivable form, such as lighting up the LED unit 141 beside the memory slot 24 where the DIMM memory module 34 is incorrectly installed, or alternatively display the configuration error message 201 in text form on a monitor screen 50 as illustrated in FIG. 4, for the purpose of informing the user of the incorrectly-installed DIMM memory module 34. In the embodiment of FIG. 4, for example, the monitor screen 50 displays a text message “Installed Memory Modules: DIMM1, DIMM2, DIMM4” to indicate that 3 DIMM memory modules 31, 32, 34 are currently installed, and another text message “Invalid Memory Module: DIMM4” to indicate that the last DIMM memory module 34 is incorrectly installed and thus invalid for use in memory operation. Based on this message, the user can react by removing the incorrectly-installed DIMM memory module 34 from the computer motherboard 10.

In conclusion, the invention provides a computer memory configuration inspection method and system which is designed for use with a computer motherboard for providing a memory configuration inspection function, and which is characterized by the utilization of an embedded set of memory specification data that are factory-stored in each DIMM memory module to determine whether the actual configuration of the installation of the DIMM memory modules is correct. This feature allows the user to be unnecessary to be familiar with DIMM's technical specification and nevertheless be able to install DIMM memory modules in correct configuration on the motherboard. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer memory configuration inspection method for use on a computer motherboard having a plurality of memory slots for installation of a group of memory modules, for performing a memory configuration inspection function on the installed memory modules on the computer motherboard;
the computer memory configuration inspection method comprising:
responding to a startup of the computer motherboard by reading an embedded set of memory specification data from each installed memory module on the computer motherboard;
detecting the actual configuration of each installed memory module on the computer motherboard;
comparing the actual configuration of each install memory module against each memory module's embedded memory specification data to check if each memory module is installed in correct configuration; and if any memory module is incorrectly installed in configuration, issuing a corresponding informing-enable message; and
responding to the informing-enable message by producing a configuration error message in a human-perceivable form.

2. The computer memory configuration inspection method of claim 1, wherein the memory module are DIMM (Dual Inline Memory Module) memory modules.

3. The computer memory configuration inspection method of claim 1, wherein the embedded memory specification data in each of the memory module is factory-stored in an SPD (Serial Presence Detect) memory specification data storage.

4. A computer memory configuration inspection system for use with a computer motherboard having a plurality of memory slots for installation of a group of memory modules, for performing a memory configuration inspection function on the installed memory modules on the computer motherboard;
the computer memory configuration inspection system comprising:
a specification data reading module, which is capable of responding to a startup of the computer motherboard by reading an embedded set of memory specification data from each installed memory module on the computer motherboard;
a configuration detecting module, which is capable of detecting the actual configuration of each installed memory module on the computer motherboard;
a comparison module, which is capable of comparing the actual configuration of each install memory module detected by the configuration detecting module against each memory module's embedded memory specification data retrieved by the specification data reading module to check if each memory module is installed in correct configuration; and if any memory module is incorrectly installed in configuration, capable of issuing a corresponding informing-enable message; and
an informing module, which is capable of responding to the informing-enable message from the comparison module by producing a configuration error message in a human-perceivable form.

5. The computer memory configuration inspection system of claim 4, wherein the memory module are DIMM (Dual Inline Memory Module) memory modules.

6. The computer memory configuration inspection system of claim 4, wherein the embedded memory specification is stored in an SPD (Serial Presence Detect) memory specification data storage in each memory module.

7. The computer memory configuration inspection system of claim 4, wherein the informing module includes an array of LED (Light-Emitting Diode) units installed beside the memory slots on the computer motherboard for displaying the configuration error message in a light signal form.

8. The computer memory configuration inspection system of claim 4, wherein the informing module displays the configuration error message in text form on a monitor screen.
